(19) United States
(12) Patent Application Publication
(10) Pub. No.: US 2014/0186042 A1
(43) Pub. Date: Jul. 3, 2014

(54) OPTICAL RECEIVER HAVING WAVELENGTH RECOGNITION FUNCTION, AND DEVICE AND METHOD FOR RECOGNIZING WAVELENGTHS USING THE SAME

(71) Applicant: Electronics and Telecommunications Research Institute, Daejeon-si (KR)

(72) Inventors: Sil-Gu MUN, Daejeon-si (KR); Eun-Gu LEE, Daejeon-si (KR); Eui-Suk JUNG, Daejeon-si (KR); Sang-Soo LEE, Daejeon-si (KR)

(73) Assignee: Electronics and Telecommunications Research Institute, Daejeon-si (KR)

(21) Appl. No.: 13/964,569

(22) Filed: Aug. 12, 2013

(30) Foreign Application Priority Data
Jan. 2, 2013 (KR) 10-2013-0000307

(51) Int. Cl. H04B 10/60

(52) U.S. Cl. CPC H04B 10/60
USPC 398/79; 398/202

(57) ABSTRACT

Provided are an optical receiver having a wavelength recognition function, and a device and method for recognizing wavelengths using the same. The optical receiver according to an embodiment of the invention includes a splitter configured to split light intensity of input optical signals, a first receiver configured to photoelectrically convert the optical signals split using the splitter, a filter having different pass band characteristics based on wavelengths of the optical signals split using the splitter, a second receiver configured to photoelectrically convert the optical signals passing through the filter, and a comparator configured to compare the optical signals respectively, photoelectrically converted by the first and second receivers and recognize wavelengths of the input optical signals.

### CROSS-REFERENCE TO RELATED APPLICATION

This application claims the benefit under 35 U.S.C. §119(a) of Korean Patent Application No. 10-2013-0000307, filed on Jan. 2, 2013, in the Korean Intellectual Property Office, the entire disclosure of which is incorporated herein by reference for all purposes.

### BACKGROUND

1. Field

The following description relates to an optical receiver, and more particularly, to technology for recognizing wavelengths using an optical receiver in a system using wavelength-division multiplexing.

2. Description of the Related Art

Due to exponential growth of content including video, data, and sound, and use of a variety of applications of smartphones, a high bandwidth per subscriber is required in order to seamlessly accommodate in the wired traffic. Methods of expanding capacity of subscriber networks include, for example, coarse wavelength division multiplexing (hereinafter referred to as ‘CWDM’), and dense wavelength division multiplexing (hereinafter referred to as ‘DWDM’).

Since the CWDM method uses a distributed feedback-laser diode (DFB-LD) without a thermostat and a thin film CWDM filter, it is suitable for implementing an economic subscriber network. Moreover, the DWDM method is conveniently used to accommodate a plurality of subscribers in a narrow wavelength bandwidth.

Both CWDM and DWDM methods use a transceiver having a light source that outputs a specific wavelength and need a wavelength measuring device for identifying wavelengths or channels of ports at a location where the transceiver is installed at home. For its intended purpose, the wavelength measuring device needs portability to easily carry and measure, stability, and economic feasibility of implementation at a low cost.

Recently, mobile carriers build communication networks, for example, long term evolution (LTE), which results in growing demand for CWDM and DWDM modules in a section Fronthaul. Therefore, demands for the wavelength recognizing device are expected to further increase.

Examples of technology for measuring wavelengths include Korean Unexamined Patent Application Publication Nos. 10-2003-0055564 and 10-2012-0039327. However, these technologies require bulky components to measure wavelengths and high cost. Furthermore, it is difficult to downsize due to additional optical elements.

### SUMMARY

The following description relates to an optical receiver that easily recognizes wavelengths of a variety of light sources in a system using wavelength-division multiplexing, is cheap, small, and easily implemented, and a device and method for recognizing wavelengths using the same.

In one general aspect, there is provided an optical receiver including a splitter configured to split light intensity of input optical signals, a first receiver configured to photoelectrically convert the optical signals split using the splitter, a filter having different pass band characteristics based on wavelengths of the optical signals split using the splitter, a second receiver configured to photoelectrically convert the optical signals passing through the filter, and a comparator configured to compare the signals respectively, photoelectrically converted by the first and second receivers and recognize wavelengths of the input optical signals.

The filter may have inherent pass band characteristics for each wavelength in order to generate a different light intensity loss for each wavelength of input optical signals. That is, the filter may have different pass band characteristics based on wavelengths in a predetermined wavelength band among wavelength bands of a light source for CWDM in order to recognize wavelengths of a light source for CWDM. Or, the filter may have different pass band characteristics based on wavelengths in a predetermined wavelength band among wavelength bands of a light source for DWDM in order to recognize wavelengths of a light source for DWDM. The predetermined wavelength band may be O-band (1260 to 1360 nm), E-band (1360 to 1460 nm), S-band (1460 to 1530 nm), C-band (1530 to 1565 nm), L-band (1565 to 1625 nm), or U-band (1625 to 1675 nm).

The pass band characteristics of the filter may be selected by a user according to wavelength bands to use. The filter may be a thin film filter.

The comparator may include a built-in analog-to-digital converter that generates digital values by respectively digitalizing the signals photoelectrically converted by the first and second receivers, compare the digital values generated by the analog-to-digital converter or calculate a difference value of the generated digital values, and recognize wavelengths of the input optical signals based on comparison or calculation results.

The optical receiver may further include an analog-to-digital converter configured to generate digital values by digitalizing signals photoelectrically converted by the first and second receivers, in which the comparator may compare digital values generated by the analog-to-digital converter or calculate a difference value of the generated digital values, and recognize wavelengths of the input optical signals based on comparison or calculation results.

In another aspect, there is provided an optical receiver including a splitter configured to split light intensity of input optical signals, N filters each having different pass band characteristics based on wavelengths of the optical signals split using the splitter, N receivers configured to photoelectrically convert the optical signals passing through the N filters, and a comparator configured to compare the signals photoelectrically converted by the N receivers and recognize wavelengths of the input optical signals.

The N filters may include a first filter having different pass band characteristics based on wavelengths in a predetermined wavelength band among wavelength bands of a light source for CWDM in order to recognize a light source for CWDM and a second filter having different pass band characteristics based on wavelengths in a predetermined wavelength band among wavelength bands of a light source for CWDM in order to recognize a light source for CWDM.

The N filter may include a first filter having different pass band characteristics based on wavelengths in a predetermined wavelength band among wavelength bands of a light source for DWDM in order to recognize a light source for DWDM and a second filter having different pass is band characteristics based on wavelengths in a predetermined wavelength band among wavelength bands of a light source for DWDM in order to recognize a light source for DWDM. The N filters may be thin film filters.

In still another aspect, there is provided a method of recognizing wavelengths using an optical receiver including splitting light intensity of input optical signals using a splitter, photoelectrically converting the split optical signals, filtering the split optical signals using a filter having different pass band characteristics based on wavelengths and photoelectrically converting the optical signals passing through the filter, and comparing each of the photoelectrically converted signals and recognizing wavelengths of the input optical signals.

The filter may have different pass band characteristics based on wavelengths in a predetermined wavelength band among wavelength bands of a light source for CWDM in order to recognize wavelengths of a light source for CWDM. Or, the filter may have different pass band characteristics based on wavelengths in a predetermined wavelength band among wavelength bands of a light source for DWDM in order to recognize wavelengths of a light source for DWDM.

The method of recognizing wavelengths may further include inputting input optical signals to the splitter by connecting to a device under test and outputting a wavelength recognizing result of the input optical signals to the outside.

Other features and aspects will be apparent from the following detailed description, the drawings, and the claims.

### BRIEF DESCRIPTION OF THE DRAWINGS

FIG. 1 is a diagram illustrating a configuration of an optical receiver having a wavelength recognition function according to an embodiment of the invention.

FIG. 2 is a reference diagram illustrating filter characteristics of the optical receiver in FIG. 1 according to the embodiment of the invention.

FIG. 3 is a diagram illustrating a configuration of a wavelength recognizing device including the optical receiver having a wavelength recognition function according to the embodiment of the invention.

FIG. 4 is a reference diagram illustrating wavelength bands of a light source for CWDM according to the embodiment of the invention.

FIG. 5 is a reference diagram illustrating wavelength bands of a light source for DWDM according to the embodiment of the invention.

FIG. 6 is a diagram illustrating a configuration of an optical receiver having a wavelength recognition function according to another embodiment of the invention.

FIG. 7 is a diagram illustrating a generalized configuration of the optical receiver having a wavelength recognition function according to the embodiment of the invention.

FIG. 8 is a reference diagram illustrating a method of recognizing wavelengths using the optical receiver having a wavelength recognition function according to the embodiment of invention.

FIG. 9 is a reference diagram illustrating a method of recognizing wavelengths using the optical receiver having a wavelength recognition function according to another embodiment of invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, exemplary embodiments of the invention will be described in detail with reference to the accompanying drawings. When it is determined that detailed explanations of related well-known functions or configurations unnecessarily obscure gist of the embodiments, the detailed description thereof will not be repeated. The terminology used herein is defined by considering a function in the embodiments, and meanings may vary depending on, for example, a user or operator's intentions or customs. Therefore, the meanings of terms used in the embodiments should be interpreted based on the scope throughout this specification.

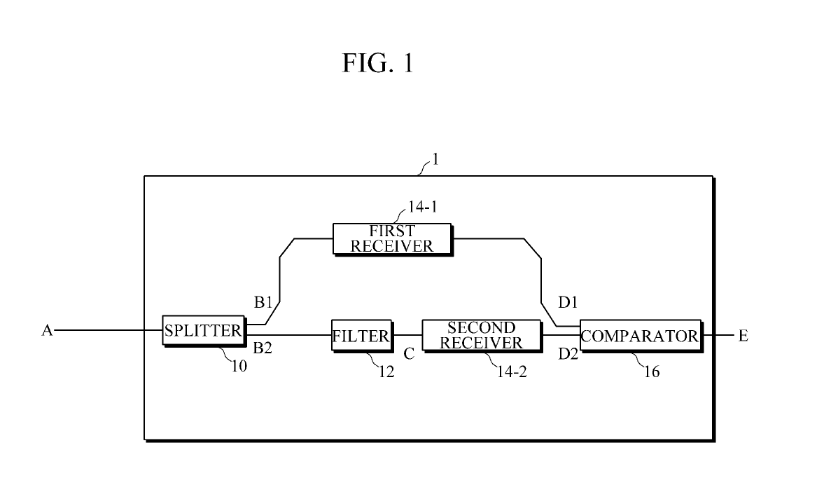

FIG. 1 is a diagram illustrating a configuration of an optical receiver 1 having a wavelength recognition function according to an embodiment of the invention.

As illustrated in FIG. 1, the optical receiver 1 includes a splitter 10, a filter 12, a first receiver 14-1, a second receiver 14-2, and a comparator 16.

The splitter 10 is an element for splitting light intensity of input optical signals, splits light intensity into a ratio of m:n (m and n are arbitrary positive integers) according to a setting from a user, and inputs the split light intensity to the first receiver 14-1 and filter 12. The input optical signals may be split into the first receiver 14-1 and filter 12 according to the light intensity split ratio of, for example, 9:1, 2:1, and 1:1. In this specification, it is assumed that light intensity is split into a ratio of 1:1 in order to simplify the description.

The first and second receivers 14-1 and 14-2 are photoelectric elements that convert optical signals to electronic signals. Examples of the photoelectric element may include a photodiode, an avalanche photodiode, and a monitoring photodiode suitable as a monitoring receiver. Besides, any type of elements having a measuring function may be used. In particular, since the monitoring photodiode has a lower dark current than other photoelectric element, it is possible to distinguish very small light and suitable for the first and second receivers 14-1 and 14-2.

The filter 12 has different pass band characteristics based on wavelengths. That is, the filter 12 has different attenuation values based on wavelengths in a range of specific wavelengths for each wavelength of input optical signals.

The filter 12 may be a thin film filter. In this case, it is possible to manufacture a filter that has pass band characteristics as desired according to design conditions. That is, the user may select and use the pass band characteristics of the filter 12 according to a wavelength band to use. In addition, since the filter 12 is manufactured in a small size, for example, about 2 mm×2 mm, it can be modularized and integrated into a single element. A detailed description of the pass band characteristics of the filter 12 will be described below.

The comparator 16 compares values photoelectrically converted by the first and second receivers 14-1 and 14-2, and recognizes wavelengths or channels of input optical signals. In this case, the comparator 16 may compare two signal values or calculate a difference value of two signal values, and recognize wavelengths or channels of the input optical signals. For example, the comparator 16 compares signals photoelectrically converted by the first receiver 14-1 and signals photoelectrically converted by the second receiver 14-2, and recognizes wavelengths of the input optical signals by identifying a different wavelength band between the two signals. As another example, the comparator 16 calculates a difference value between is signals photoelectrically converted by the first receiver 14-1 and signals photoelectrically converted by the second receiver 14-2, and recognizes wavelengths of the input optical signals by identifying a wavelength band corresponding to the difference value.

According to the embodiment, the comparator 16 includes a built-in analog-to-digital converter (hereinafter referred to as ‘ADC’) (not illustrated). The ADC generates digital values by respectively digitalizing signals photoelectrically converted by the first and second receivers 14-1 and 14-2. In this case, the comparator 16 compares the digital values respectively generated by the ADC or calculates a difference value of the respectively generated digital values. In addition, wavelengths or channels of input optical signals are recognized based on the comparison or calculation results.

Meanwhile, the ADC may be arranged in a front stage of the comparator 16 separated from the comparator 16 other than built-in in the comparator 16. In this case, the comparator 16 compares digital values respectively generated by the ADC or calculates a difference value of the respectively generated digital values, and recognizes wavelengths of the input optical signals based on the comparison or calculation results.

The ADC may be implemented by a simple and common IC having an ADC function. Since the ADC has a variety of resolutions, the user may select and use an ADC suitable for a range of input signals in accordance with the resolution.

Hereinafter, wavelength recognizing processes of the optical receiver 1 having a wavelength recognition function will be described below. As illustrated in FIG. 1, the optical receiver 1 splits light intensity of optical signals input from A into two signals B1 and B2 using the splitter 10. As described above, although it is possible to split with a variety of ratio for its intended purpose, it is assumed that light intensity is split into a ratio of 1:1 in order to simplify the description. Accordingly, optical signals having the same light intensity are input to the first receiver 14-1 and the filter 12. Signals D1 output from the first receiver 14-1 are photoelectrically converted signals. Optical signals C passing through the filter 12 having different pass band characteristics based on wavelengths have different light intensity according to wavelength bands of input signals. Then, signals D2 photoelectrically converted by the second receiver 14-2 are obtained. Subsequently, the comparator 16 compares values of photoelectrically converted D1 and D2 and recognizes wavelength bands or channel values of the input signals. For example, the comparator 16 calculates a difference value between the photoelectrically converted signals D1 and D2, identifies a wavelength band corresponding to the difference value, and recognizes wavelengths of the input optical signals.

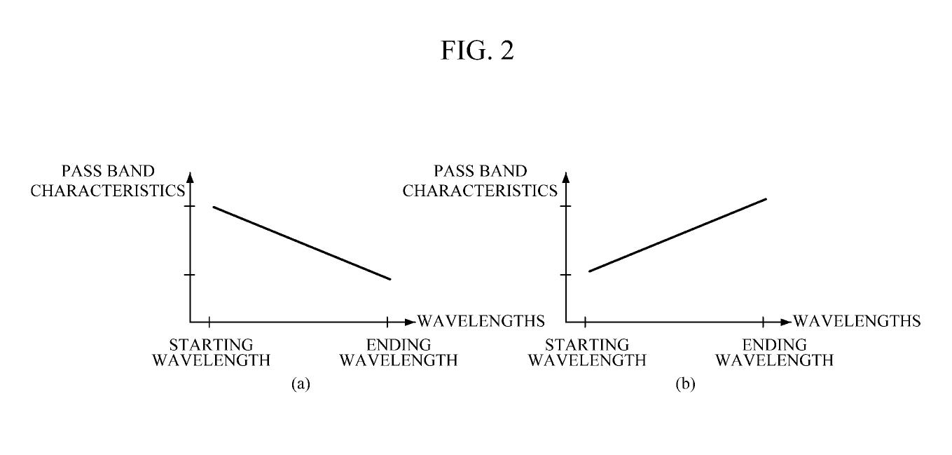

FIG. 2 is a reference diagram illustrating characteristics of the filter 12 of the optical receiver 1 in FIG. 1 according to the embodiment of the invention.

As illustrated in FIG. 2, the invention uses a filter having different pass band characteristics based on wavelengths in order to recognize wavelengths of input optical signals. As illustrated in FIGS. 2A and 2B, when the filter having inherent pass band characteristics for each wavelength of input optical signals is used, it is possible to recognize wavelengths due to a different light intensity loss for each wavelength. FIG. 2A illustrates pass band characteristics based on wavelengths when a starting wavelength has a relatively low loss and an ending wavelength has a relatively high loss. FIG. 2B illustrates pass band characteristics based on wavelengths when a starting wavelength has a relatively high loss and an ending wavelength has a relatively low loss. Both cases may be applied to the present invention and easy filter manufacturing is possible due to mature thin film filter design technology over the years.

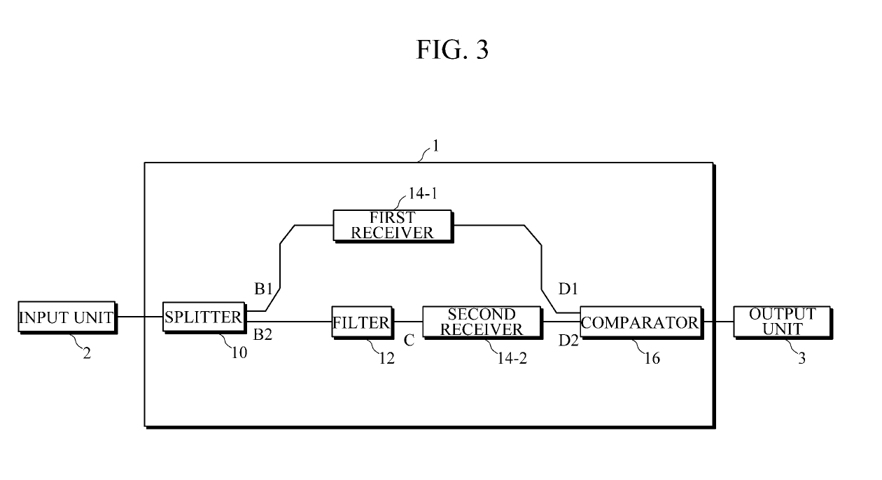

FIG. 3 is a diagram illustrating a configuration of a wavelength recognizing device including the optical receiver 1 having a wavelength recognition function according to the embodiment of the invention.

As illustrated in FIG. 3, the wavelength recognizing device includes the optical receiver 1, an input unit 2, and an output unit 3. The optical receiver 1 includes the splitter 10, the filter 12, the first receiver 14-1, the second receiver 14-2, and the comparator 16.

The input unit 2 connects a device under test (DUT) (not illustrated) to test and the optical receiver 1 having a wavelength recognition function, and closely links the DUT and the optical receiver 1. Examples of the input unit 2 may include an optical adapter input device capable of accommodating an optical adapter and an input device capable of inputting directly to a bare optical fiber for its intended purpose. Light intensity of optical signals input to the input unit 2 is split using the splitter 10. The output unit 3 outputs results output from the comparator 16 to the outside and may be implemented using, for example, an LED, an LCD, and a GUI screen. Specific configurations of the splitter 10, the filter 12, the first and second receivers 14-1 and 14-2, and the comparator 16 of the optical receiver 1 are the same as FIG. 1 described above.

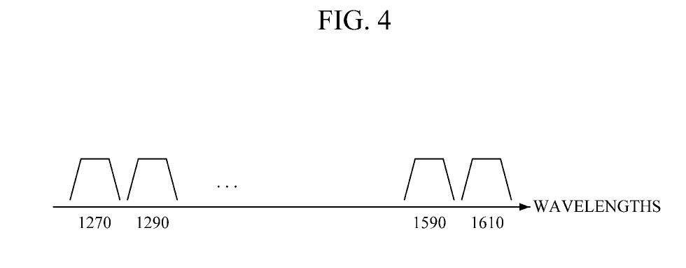

FIG. 4 is a reference diagram illustrating wavelength bands of a light source for CWDM according to the embodiment of the invention.

As illustrated in FIG. 4, wavelength bands of a light source for CWDM from 1270 nm to 1610 nm with an interval of 20 nm are used, and a pass bandwidth is about 13 nm. In order to distinguish wavelength bands of a light source for CWDM, in case of the filter 12 in FIG. 1, a filter having different pass band characteristics in a range of 340 (from 1270 to 1610) nm wavelengths may be used. Meanwhile, the embodiment in FIG. 4 is just an example to facilitate understanding of the invention and wavelength bands of a light source and wavelength band characteristics of the filter may be variously modified.

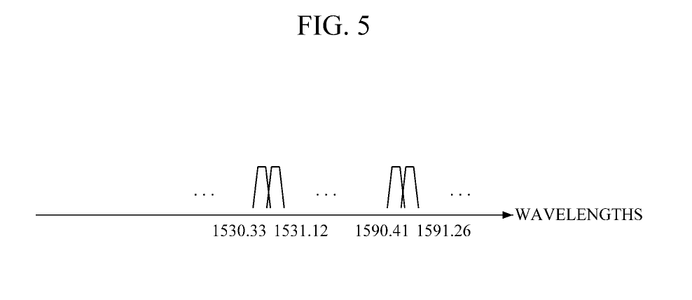

FIG. 5 is a reference diagram illustrating wavelength bands of a light source for DWDM is according to the embodiment of the invention.

As illustrated in FIG. 5, wavelength bands of a light source for DWDM are divided into a wavelength interval of, for example, about 1.6 nm, 0.8 nm, and 0.4 nm, for each channel depending on the method used, and pass bands also vary accordingly. For more information on detailed wavelength bands, refer to Standard Wavelength Reference Table defined by ITU-T.

Since a light source for DWDM has a narrow interval between channels, when distinguishing wavelengths of a light source for DWDM, it is possible to use a filter having different pass band characteristics based on wavelengths in the corresponding wavelength band by considering which is primarily used wavelength band, for example, O-band (1260 to 1360 nm), E-band (1360 to 1460 nm), S-band (1460 to 1530 nm), C-band (1530 to 1565 nm), L-band (1565 to 1625 nm) or U-band (1625 to 1675 nm).

For its intended purpose, a filter capable of distinguishing both of wavelength bands of a light source for CWDM and wavelength bands of a light source for DWDM may be used in the optical receiver. Meanwhile, the embodiment in FIG. 5 is just an example to facilitate understanding of the invention and wavelength bands of a light source and wavelength band characteristics of the filter may be variously modified.

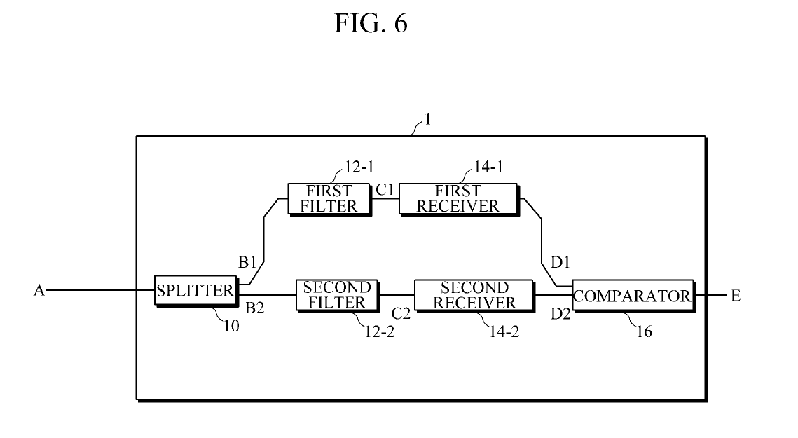

FIG. 6 is a diagram illustrating a configuration of an optical receiver 1 having a wavelength recognition function according to another embodiment of the invention.

As illustrated in FIG. 6, the optical receiver 1 includes a splitter 10, a first filter 12-1, a second filter 12-2, a first receiver 14-1, a second receiver 14-2, and a comparator 16.

In FIG. 6, the filter 12 in FIG. 1 is configured with the first and second filters 12-1 and 12-2, and functions of the splitter 10 and the first and second receivers 14-1 and 14-2 are the same as FIG. 1 described above. The first and second filters 12-1 and 12-2 have different pass band characteristics based on wavelengths.

Hereinafter, wavelength recognizing processes of the optical receiver 1 will be described below with reference to FIG. 6. As illustrated in FIG. 6, the splitter 10 splits light intensity of signals input from A into two signals B1 and B2. Then, the signal B1 is input to the first filter 12-1 having a different pass band based on wavelengths, and after passing through the first filter 12-1, signal C1 is obtained. Then, signal D1 that is the signal C1 photoelectrically converted by the first receiver 14-1 is obtained. Similarly, after the signal B2 passes through the second filter 12-2 having a different pass band based on wavelengths, signal C2 is obtained. Then, signal D2 that is the signal C2 photoelectrically converted by the second receiver 14-2 is obtained. The comparator 16 compares values of photoelectrically converted signals D1 and D2, recognizes wavelength bands or channels values of input signals, and outputs recognition results.

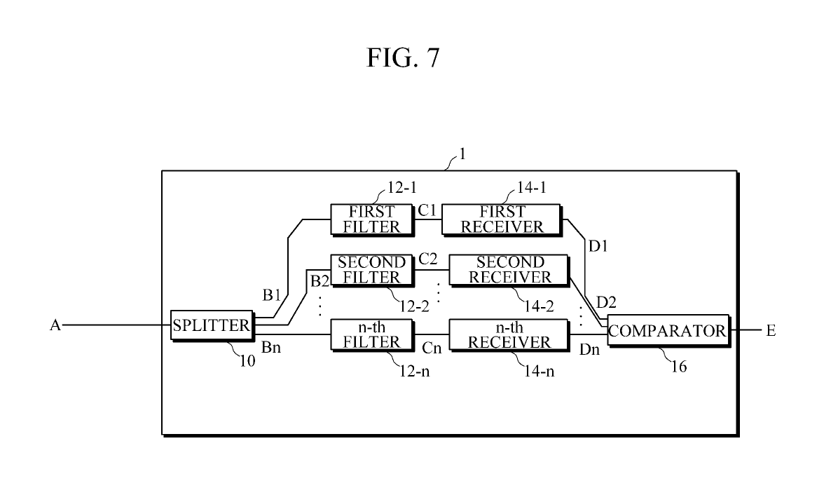

FIG. 7 is a diagram illustrating a generalized configuration of the optical receiver 1 having a wavelength recognition function according to the embodiment of the invention.

As illustrated in FIG. 7, the optical receiver 1 includes the splitter 10, N filters 12-1, 12-2, . . . , and 12-n, the N receivers 14-1, 14-2, . . . , and 14-n, and the comparator 16.

Functions of the splitter 10 and the N receivers 14-1, 14-2, . . . , and 14-n are the same as in FIG. 1 described above. The N filters 12-1, 12-2, . . . , and 12-n have different pass band characteristics based on wavelengths.

Hereinafter, wavelength recognizing processes of the optical receiver 1 having a wavelength recognition function will be described below with reference to FIG. 7. As illustrated in FIG. 7, the splitter 10 splits light intensity of signals input from A into N optical signals B1, B2, . . . , and Bn. Then, the signal B1 is input to the first filter 12-1 having a different pass band based on wavelengths, and after passing through the first filter 12-1, signal C1 is obtained. Then, signal D1 that is the signal C1 photoelectrically converted by the first receiver 14-1 is obtained. Similarly, after the signal B2 passes through the second filter 12-2 having a different pass band based on wavelengths, signal C2 is obtained. Then, signal D2 that is the signal C2 photoelectrically converted by the second receiver 14-2 is obtained. Likewise, after the signal Bn passes through the n-th filter 12-n having a different pass band based on wavelengths, signal Cn is obtained. Then, signal Dn that is the signal Cn photoelectrically converted by the n-th receiver 14-n is obtained. The comparator 16 compares values of photoelectrically converted signals D1, D2, . . . , and Dn, recognizes wavelength bands or channels values of input signals, and outputs recognition results.

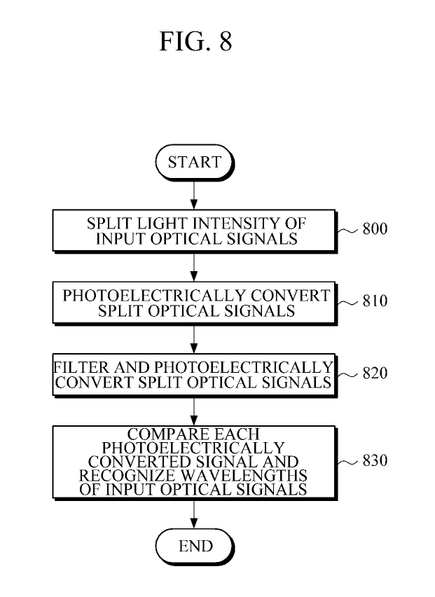

FIG. 8 is a reference diagram illustrating a method of recognizing wavelengths using the optical receiver having a wavelength recognition function according to the embodiment of invention.

As illustrated in FIG. 8, the wavelength recognizing device splits light intensity of input optical signals using the splitter in 800.

Subsequently, the split optical signals are photoelectrically converted in 810, and after the split optical signals are filtered using the filter, the optical signals passing through the filter are photoelectrically converted in 820. The filter has different pass band characteristics based on wavelengths. Then, each of the photoelectrically converted signals is compared, and wavelengths of the input optical signals are recognized in 830.

The filter may have different pass band characteristics based on wavelengths in a predetermined wavelength band among wavelength bands of a light source for CWDM in order to recognize wavelengths of a light source for CWDM. Or, the filter may have different pass band characteristics based on wavelengths in a predetermined wavelength band among is wavelength bands of a light source for DWDM in order to recognize wavelengths of a light source for DWDM

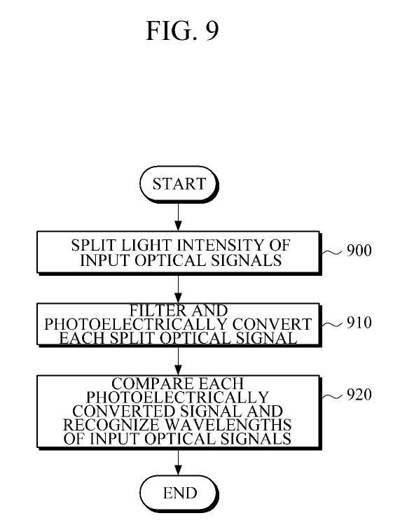

FIG. 9 is a reference diagram illustrating a method of recognizing wavelengths using the optical receiver having a wavelength recognition function according to another embodiment of invention.

As illustrated in FIG. 9, the wavelength recognizing device splits light intensity of input optical signals in 900.

Subsequently, after the split optical signals are filtered using each filter, the optical signals passing through each filter are respectively, photoelectrically converted in 910. Each filter has different pass band characteristics based on wavelengths.

According to the embodiment, the filter may include a first filter having different pass band characteristics based on wavelengths in a predetermined wavelength band among wavelength bands of a light source for CWDM in order to recognize a light source for CWDM and a second filter having different pass band characteristics based on wavelengths in a predetermined wavelength band among wavelength bands of a light source for CWDM in order to recognize a light source for CWDM.

According to another embodiment, the filter may include a first filter having different pass band characteristics based on wavelengths in a predetermined wavelength band among wavelength bands of a light source for DWDM in order to recognize a light source for DWDM and a second filter having different pass band characteristics based on wavelengths in a predetermined wavelength band among wavelength bands of a light source for DWDM in order to recognize a light source for DWDM.

Subsequently, the wavelength recognizing device compares each of the photoelectrically converted signals and recognizes wavelengths of input optical signals in 920.

While the present invention has been particularly described with reference to exemplary embodiments, it will be understood by those of skilled in art that various changes in form and details may be made without departing from the spirit and scope of the present invention. Therefore, the exemplary embodiments should be considered in a descriptive sense only and not for purposes of limitation. The scope of the invention is defined not by the detailed description of the invention but by the appended claims, and encompasses all modifications and equivalents that fall within the scope of the appended claims and will be construed as being included in the present invention.

According to the embodiment, it is possible to recognize wavelengths of a light source for CWDM and a light source for DWDM. Further, since mature thin film filter technologies are used, which can be applied to various wavelength bands. In addition, a thin film filter used for a wavelength recognizing device of the invention may be manufactured in a small size, thereby being modularized and integrated into a single element. Since expensive optical components are not used herein, it is possible to implement at a low cost. Moreover, since wavelengths of input optical signals are recognized by comparing signals, it is sturdy against external noises, for example, changes in receiving light intensity.

The present invention can be implemented as computer-readable codes in a computer-readable recording medium. The computer-readable recording medium includes all types of recording media in which computer-readable data is stored. Examples of the computer-readable recording medium include a ROM, a RAM, a CD-ROM, a magnetic tape, a floppy disk, and an optical data storage. Further, the recording medium may be implemented in the form of carrier waves, such as those used in Internet transmission. In addition, the computer-readable recording medium may be distributed among computer systems over a network such that computer-readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical receiver comprising:
a splitter configured to split light intensity of input optical signals;
a first receiver configured to photoelectrically convert the optical signals split using the splitter;
a filter having different pass band characteristics based on wavelengths of the optical signals split using the splitter;
a second receiver configured to photoelectrically convert the optical signals passing through the filter; and
a comparator configured to compare the signals respectively, photoelectrically converted by the first and second receivers and recognize wavelengths of the input optical signals.

2. The optical receiver according to claim 1, wherein the filter is a thin film filter.

3. The optical receiver according to claim 1, wherein the filter has inherent pass band characteristics for each wavelength in order to generate a different light intensity loss for each wavelength of input optical signals.

4. The optical receiver according to claim 3, wherein the filter has different pass band characteristics based on wavelengths in a predetermined wavelength band among wavelength bands of a light source for CWDM in order to recognize wavelengths of a light source for CWDM.

5. The optical receiver according to claim 3, wherein the filter has different pass band characteristics based on wavelengths in a predetermined wavelength band among wavelength bands of a light source for DWDM in order to recognize wavelengths of a light source for DWDM.

6. The optical receiver according to claim 5, wherein the predetermined wavelength band includes O-band (1260 to 1360 nm), E-band (1360 to 1460 nm), S-band (1460 to 1530 nm), C-band (1530 to 1565 nm), L-band (1565 to 1625 nm), or U-band (1625 to 1675 nm).

7. The optical receiver according to claim 1, wherein the pass band characteristics of the filter are selected by a user according to wavelength bands to use.

8. The optical receiver according to claim 1, wherein the comparator includes a is built-in analog-to-digital converter that generates digital values by respectively digitalizing the signals photoelectrically converted by the first and second receivers, compares the digital values respectively generated by the analog-to-digital converter or calculates a difference value of the respectively generated digital values, and recognizes wavelengths of the input optical signals based on comparison or calculation results.

9. The optical receiver according to claim 1, further comprising an analog-to-digital converter configured to generate digital values by digitalizing signals photoelectrically converted by the first and second receivers,
wherein the comparator compares digital values respectively generated by the analog-to-digital converter or calculates a difference value of the respectively generated digital values, and recognizes wavelengths of the input optical signals based on comparison or calculation results.

10. An optical receiver comprising:
a splitter configured to split light intensity of input optical signals;
N filters each having different pass band characteristics based on wavelengths of the optical signals split using the splitter;
N receivers configured to photoelectrically convert the optical signals passing through the N filters; and
a comparator configured to compare the signals photoelectrically converted by the N receivers and recognize wavelengths of the input optical signals.

11. The optical receiver according to claim 10, wherein the N filters include:
a first filter having different pass band characteristics based on wavelengths in a predetermined wavelength band among wavelength bands of a light source for CWDM in order to recognize a light source for CWDM; and
a second filter having different pass band characteristics based on wavelengths in a predetermined wavelength band among wavelength bands of a light source for CWDM in order to recognize a light source for CWDM.

12. The optical receiver according to claim 10, wherein the N filters include:
a first filter having different pass band characteristics based on wavelengths in a predetermined wavelength band among wavelength bands of a light source for DWDM in order to recognize a light source for DWDM; and
a second filter having different pass band characteristics based on wavelengths in a predetermined wavelength band among wavelength bands of a light source for DWDM in order to recognize a light source for DWDM.

13. The optical receiver according to claim 10, wherein the N filters are thin film filters.

14. A method of recognizing wavelengths using an optical receiver comprising:
splitting light intensity of input optical signals using a splitter;
photoelectrically converting the split optical signals;
filtering the split optical signals using a filter having different pass band characteristics is based on wavelengths and photoelectrically converting the optical signals passing through the filter; and
comparing each of the photoelectrically converted signals and recognizing wavelengths of the input optical signals.

15. The method according to claim 14, wherein the filter has different pass band characteristics based on wavelengths in a predetermined wavelength band among wavelength bands of a light source for CWDM in order to recognize wavelengths of a light source for CWDM.

16. The method according to claim 14, wherein the filter has different pass band characteristics based on wavelengths in a predetermined wavelength band among wavelength bands of a light source for DWDM in order to recognize wavelengths of a light source for DWDM.

17. The method according to claim 14, further comprising inputting input optical signals to the splitter by connecting to a device under test.

18. The method according to claim 14, further comprising outputting a wavelength recognizing result of the input optical signals to the outside.
